(19) United States
(12) Patent Application Publication
(10) Pub. No.: US 2014/0122234 A1
(43) Pub. Date: May 1, 2014

(54) ENTITY BASED ADVERTISEMENT TARGETING

(71) Applicants: Gideon WALD, San Francisco, CA (US); Kathryn CUSHING, San Francisco, CA (US); Thomas Christian WILTZIUS, Santa Barbara, CA (US); Gregory Matthew MARRA, San Francisco, CA (US)

(72) Inventors: Gideon WALD, San Francisco, CA (US); Kathryn CUSHING, San Francisco, CA (US); Thomas Christian WILTZIUS, Santa Barbara, CA (US); Gregory Matthew MARRA, San Francisco, CA (US)

(21) Appl. No.: 13/781,541

(22) Filed: Feb. 28, 2013

Related U.S. Application Data
(60) Provisional application No. 61/720,950, filed on Oct. 31, 2012.

(51) Int. Cl. G06Q 30/02

(52) U.S. Cl. CPC G06Q 30/0256
USPC 705/14.54

(57) ABSTRACT

Various aspects of the subject technology relate to systems, methods, and machine-readable media for targeting an advertisement based on an entity. A system is configured to receive a search query submitted by a user, identify an entity in a concept entity graph based on the search query, determine whether an advertisement corresponds to the identified entity, and provide, if the advertisement corresponds to the entity, the advertisement for display to the user.

### RELATED APPLICATION

This application claims priority to U.S. provisional patent application 61/720,950, filed on Oct. 31, 2012, entitled “ENTITY BASED ADVERTISEMENT TARGETING,” the contents of which are herein incorporated by reference in its entirety.

### BACKGROUND

The present disclosure generally relates to the display of information in a user interface.

Many companies derive revenue from selling space for content items such as advertisements (“ads”). The space being sold may be in traditional media, such as television, radio, newspaper, and magazines, as well as interactive media, such as the Internet.

Search services (e.g., a search engine) may display advertisements that are associated with key words or key terms. In one scenario, an advertiser may pay a search service to display an advertisement in response to a user submitting a search query based on specific key terms. For example, a famous chef or other advertiser may wish to target an advertisement for the chef's new cook book to users who search using one or more selected key terms such as variations of the chef's name and nicknames, the names of the chef's popular restaurants, the names of other books or publications of the chef's, or other key terms. When a user submits to the search service a search query with a search term that matches one of the selected key terms, the user may be presented with the advertisement for the chef's new cook book.

### SUMMARY

Various aspects of the subject technology relate to a system for targeting an advertisement based on an entity. The system includes one or more processors and a machine-readable medium comprising instructions stored therein, which when executed by the one or more processors, cause the one or more processors to perform operations. The operations include receiving a search query submitted by a user, identifying an entity in a concept entity graph based on the search query, determining whether an advertisement corresponds to the identified entity, and providing, if the advertisement corresponds to the entity, the advertisement for display to the user.

Various aspects of the subject technology relate to a computer-implemented method for targeting an advertisement based on an entity. The method includes receiving a search query submitted by a user, identifying an entity in a concept entity graph based on the search query, determining whether an advertisement corresponds to the identified entity, and providing, if the advertisement corresponds to the entity, the advertisement for display to the user, wherein the advertisement comprises at least one social media component that corresponds to the entity.

Various aspects of the subject technology relate to a machine-readable medium including instructions stored therein, which when executed by a machine, cause the machine to perform operations for targeting an advertisement based on an entity. The operations include receiving a search query submitted by a user, identifying an entity based on the search query, determining whether an advertisement corresponds to the identified entity, and providing, if the advertisement corresponds to the entity, the advertisement for display to the user, wherein the advertisement comprises at least one social media component that corresponds to the entity.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 is a block diagram illustrating an example network environment in which a system configured to target an advertisement based on an entity may operate, in accordance with various aspects of the subject technology.

FIG. 2 is a block diagram illustrating an example system for targeting an advertisement based on an entity, in accordance with various aspects of the subject technology.

FIG. 3 is a diagram illustrating an example user interface showing an advertisement and search results provided by a search service, in accordance with various aspects of the subject technology.

FIG. 4 is a flow chart illustrating an example process for associating an advertisement with an entity, in accordance with various aspects of the subject technology.

FIG. 5 is a flow chart illustrating an example process for targeting an advertisement based on an entity, in accordance with various aspects of the subject technology.

FIG. 6 is a block diagram illustrating a computer system with which any of the devices, servers, or systems described herein may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

Some search services (e.g., search engines) allow advertisers to pay the search service to display an advertisement in response to a user submitting a search query with selected key terms. In some cases, the advertiser may wish to identify key terms related to a concept or an entity (e.g., a person, business, charities, or other organization). The advertiser, however, must select all of the key terms, which can be numerous, that will be associated with the advertisement.

According to various aspects of the subject technology, a system is configured to associate advertisements with entities and to provide users of a search service with advertisements based on an entity related to the search query. For example, instead of selecting a number of key terms, the famous chef or other advertiser in the example above can simply select one entity (e.g., the chefs entity) that the system is aware of and request that the system provide advertisements to users that submit search queries that are related to the selected entity.

Although the example discussed above relates to a chef, other advertisements may be provided for other entities as well. Entities may include businesses, organizations, other individuals, or other entities that have a profile on a social networking service.

According to some aspects, the advertisements that are provided by the search service may also contain social media components. For example, a celebrity or a publicist for the celebrity may request that the search service display an advertisement to users who submit search queries related to the celebrity. The advertisement may include, for example, a link to a social network profile for the celebrity, a link to a social network profile for a band, company, group, or other entity related to the celebrity, content from a social network profile, or an interface element to perform an action associated with a social network profile (e.g., to share content on the social network profile or add the social network profile to a list of contacts).

By providing advertisements with social media components, advertisers are able to publicize social network profiles related to entities or content that entities wish to share on their social network profiles. This may be particularly useful for advertisers that would rather market the entities themselves rather than products or services being offered by the entities. Furthermore, in some cases (e.g., for celebrities), the entities may not have products or services being offered for sale.

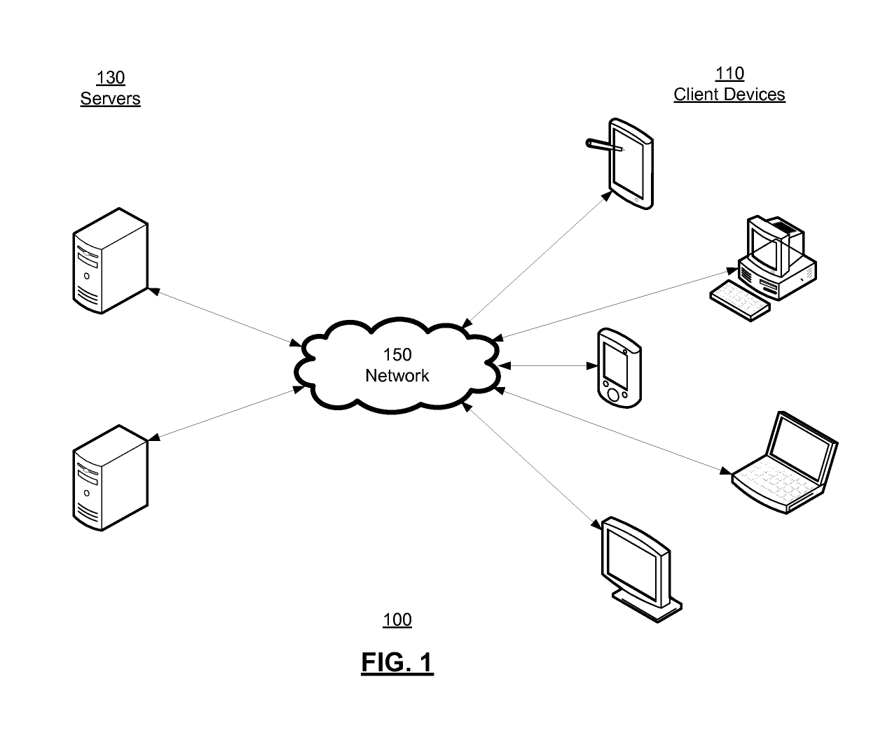

FIG. 1 is a block diagram illustrating an example network environment 100 in which a system configured to target an advertisement based on an entity may operate, in accordance with various aspects of the subject technology. The architecture includes one or more servers 130 and one or more client devices 110 connected over a network 150 such as the Internet. Although FIG. 1 illustrates a client-server network environment 100, other aspects of the subject technology may include other configurations including, for example, peer-to-peer environments or single system environments.

The client devices 110 may include, for example, desktop computers, mobile computers, tablet computers, mobile devices (e.g., a smart phone or a global positioning system (GPS) device), set top boxes (e.g., for a television), video game consoles, thin clients, or any other devices having appropriate processor, memory, and communications capabilities. The clients 110 may be configured to run applications (e.g., a web browser, a social networking application, a search service application, etc.) with which a user may submit a search query.

The servers 130 may be any computing machine or device having a processor, a memory, and communications capability for hosting a search service. The search service may be configured to receive a search query from a client device, generate search results based on the search query, and provide the search results to the client device. The search service may also request an advertisement from an advertisement (ad) service related to the search query and provide the advertisement to the client device along with the search results.

The servers 130 may also be configured to host a social networking service. The social networking service may be configured to, for example, provide users and other entities with a social network profile (e.g., a profile webpage). Users of the social networking service may also, among other things, form or join groups, receive published content from other users or entities, and publish content to other users as well. According to some aspects, the ad service, the search service, and the social networking service may be hosted on the same servers 130 or on different sets servers.

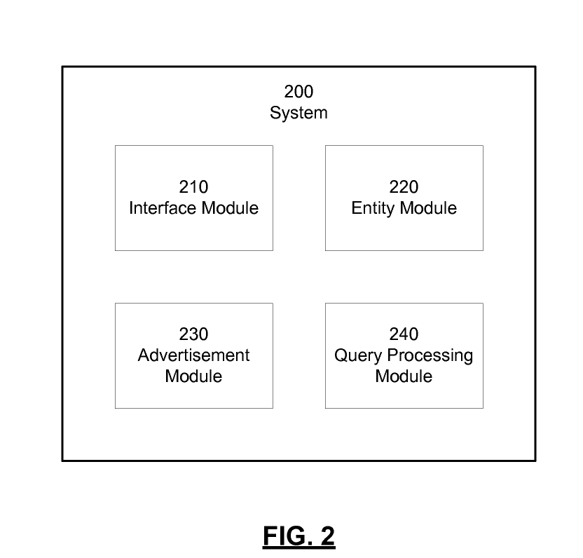

FIG. 2 is a block diagram illustrating an example system 200 for targeting an advertisement based on an entity, in accordance with various aspects of the subject technology. The system 200 may be hosted on one or more of the servers 130 in FIG. 1 or on a different machine. While the system 200 is shown in one configuration in FIG. 2, in other configurations, the system 200 may include additional, alternative, and/or fewer components.

The system 200 of FIG. 2 includes an interface module 210, an entity module 220, a query processing module 230, and an advertisement module 240. The interface module 210 is configured to receive a search query from a client device. The search query may include search terms and other information such as search parameters, a user identifier, or other user information for the user submitting the search query.

The entity module 220 identifies an entity related to the search query based on the search terms and/or any other information included in the search query. The advertisement module 230 is configured to determine whether an advertisement that is associated with the identified entity is to be provided to the client device. For example, an advertiser may pay or agree to pay a fee to have the system 200 provide an advertisement in response to a search query related to a particular entity.

If an advertisement associated with the identified entity is to be provided, the advertisement module 230 may provide the advertisement to the client device. If there is no advertisement associated with the identified entity, the advertisement module 230 may identify another advertisement to provide to the client device or provide no advertisement to the client device.

The query processing module 240 is configured to process the search query submitted by the client device, generate search results based on the search query (e.g., the search terms), and provide the search results to the client device. According to some aspects, the search results and the advertisement provided by the advertisement module 230 may be transmitted to the client device in the same communication. In other aspects, however, the search results and the advertisement may be transmitted to the client device in separate communications.

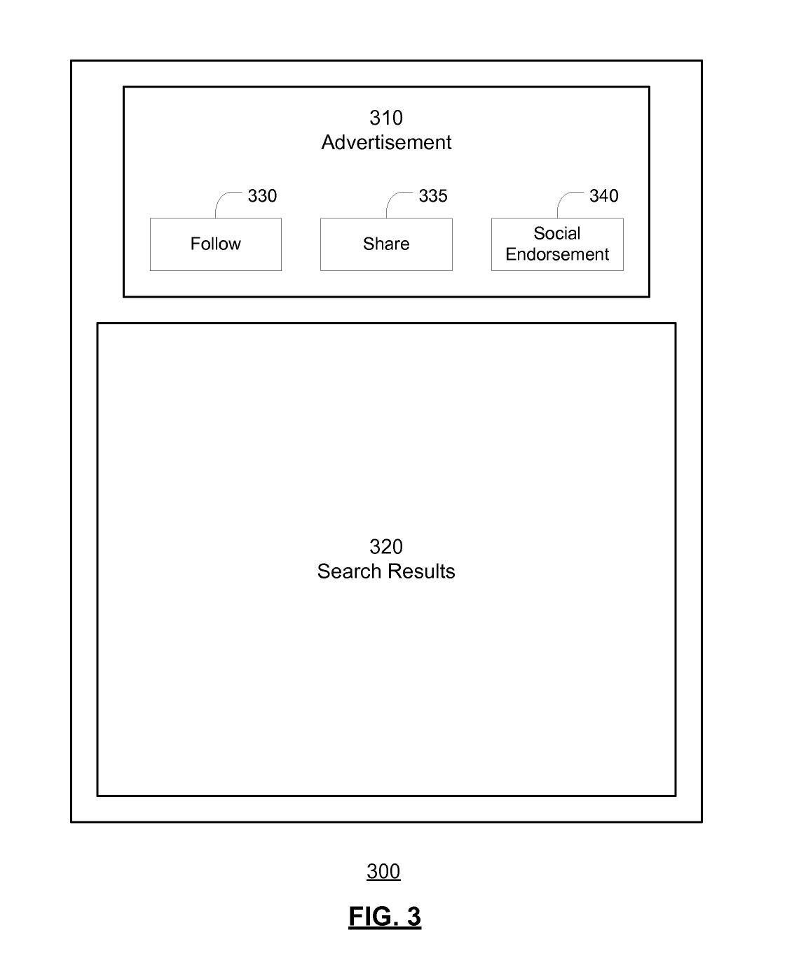

Once received by the client device, the client device may display the search results and the advertisement provided by the system 200 to the user. For example, FIG. 3 is a diagram illustrating an example user interface 300 showing an advertisement and search results provided by a search service, in accordance with various aspects of the subject technology. The user interface 300 of FIG. 3 contains an area that shows the advertisement 310 associated with an entity identified based on the search query as well as an area that shows the search results 320. According to other aspects, however, the advertisement and search results may be displayed in different configurations or on separate user interfaces displayed to the user.

The advertisement 310 may include various components related to the entity. For example, the advertisement 310 may include contact information for the entity (e.g., an address, a phone number, or an email address), links to items or services associated with the entity, or links or embedded content (e.g., videos, images, articles, etc.) featuring or authored by the entity.

According to some aspects, the advertisement 310 may also include one or more social media components that may be useful in promoting an entities social media presence. For example, the advertisement 310 can include a link to a social network profile of the entity or a social network profile of a related entity. The advertisement 310 may also include news about the entity retrieved from a news service or content, such as posts or other shared media, retrieved from one of the social network profiles.

The social media components may also include one or more interface elements (e.g., a button or link) that are configured to perform an action associated with a social network profile. For example, a user may select the “Follow” interface element 330 in FIG. 3. In response to the user selection, the client device may contact a social networking service with instructions to add the social network profile of the entity to be added to a list of social network profiles that the user may receive notifications or updates from. Alternatively, an interface element may be configured to add the social network profile of the entity to a list of contacts or a social group belonging to the user.

The social media components can also include interface elements (e.g., the “Share” interface element 335) configured to publish content in the social network profile for the entity on the social network profile of the user. Accordingly, a user selection of the interface element 335 may cause the client device to contact the social networking service with instructions to re-publish or re-share content published by an entity on the user's social networking profile or to other users receiving notifications or updates from the user. Other interface elements, such as the “Social Endorsement” interface element 340, can be used to annotate content on the social network profile for the entity with a social endorsement, thereby showing the user's approval of the content.

According to some aspects, user interactions with the various components of the advertisement may be used to determine a fee paid by an advertiser. For example, an interaction count may be kept for one or more of the components of the advertisement that a user can interact with. Each time a user interacts with components, the interaction count may be incremented. At the end of a particular period of time (e.g., an advertisement period), the system may calculate a fee to be paid by the advertiser based on the interaction count.

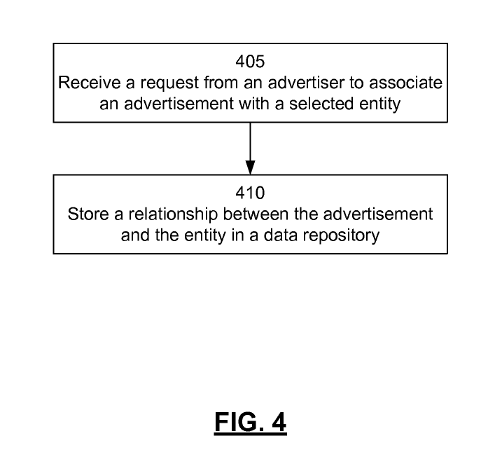

FIG. 4 is a flow chart illustrating an example process 400 for associating an advertisement with an entity, in accordance with various aspects of the subject technology. Although the blocks in FIG. 4 are discussed with respect to the modules of system 200 illustrated in FIG. 2, the steps are not limited to these modules. Furthermore, although the blocks are shown in one particular order, other orderings of blocks are also possible.

According to some aspects, an advertiser selects an entity with which to target advertisements. For example, the advertiser can access a webpage or another interface associated with the search service and enter the entity identifier (e.g., an entity name, an entity identification number, a uniform resource locator (URL) for the social network profile of the entity, etc.) into an entity field. Based on the inputted entity identifier, the webpage may identify one or more entities that may be selected. If more than one entity is identified, the advertiser may be prompted to select one of the entities from a list of the selectable entities. In other aspects, an advertiser may search for an entity by submitting an entity search query using key terms and select the entity from the entity search results.

Once an entity is selected, the advertiser may submit, to the system 200, a request to associate the selected entity with an advertisement. In some aspects, the advertiser may be able to specify the particular advertisement to be associated with the selected entity, the format or configuration of the advertisement to be associated with the selected entity, or allow the system 200 to generate the advertisement to be associated with the selected entity. The terms for payment may be included in the request or submitted to the system 200 in another communication. Furthermore, in some aspects, terms for payment to associate the advertisement with the selected entity may also be determined and agreed upon before or after the request is submitted to the system 200.

At block 405, the advertisement module 230 receives the request from the advertiser to associate the advertisement with the selected entity and process the request. For example, at block 410, the advertisement module 230 stores a relationship between the advertisement and the entity in a data repository (e.g., a database). If the advertiser specified a particular advertisement or a particular configuration (e.g., the contents and/or layout) for an advertisement, that information may also be stored in the data repository. The stored relationship between the advertisement and the entity may be used to target advertisements for search queries related to the entities.

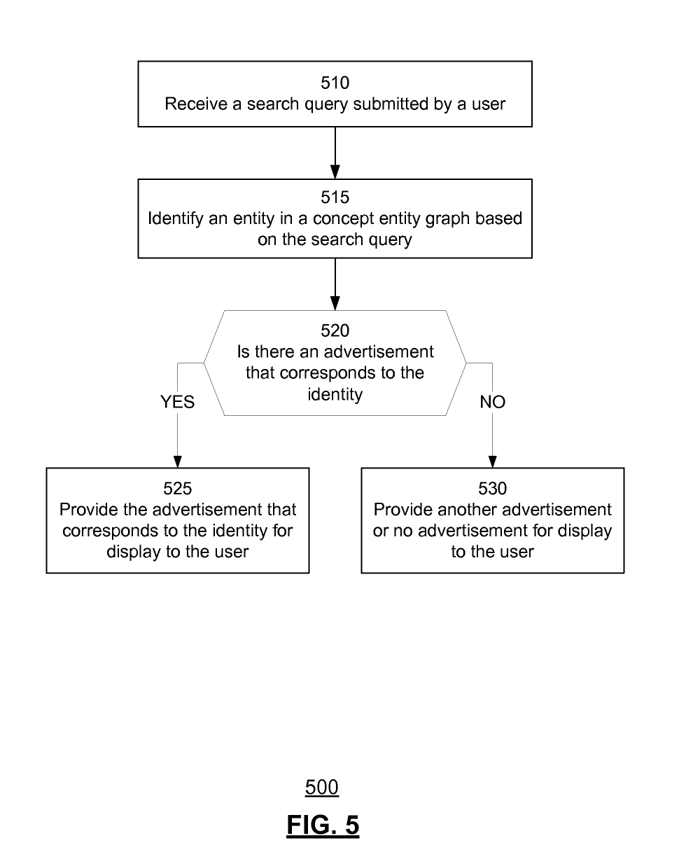

FIG. 5 is a flow chart illustrating an example process 500 for targeting an advertisement based on an entity, in accordance with various aspects of the subject technology. Although the blocks in FIG. 5 are discussed with respect to the modules of system 200 illustrated in FIG. 2, the steps are not limited to these modules. Furthermore, although the blocks are shown in one particular order, other orderings of blocks are also possible.

According to various aspects of the subject technology, a user may submit a search query using a browser or other application on a client device. At block 510, the interface module 210 receives the search query submitted by the user. The search query may include search terms and other search information such as search parameters or user information. Based on the search query, at block 515, the entity module 220 can identify an entity in a concept entity graph that includes mappings of a number of entities to information related to the entities (e.g., key terms, locations, etc.).

The entity module 220 can compare the search terms in the search query with the key terms in the concept entity graph in order to select a number of entities that may be related to the search query. If the search terms in the search query are the same as, or similar to, key terms associated with a particular entity in the concept entity graph, the entity module 220 may determine that the search query may be related to the entity. Other information, such as a location of the user and locations of the entities, may be compared and used to select entities related to the search query as well.

The number of entities may be prioritized (e.g., ranked) based on how similar the search query information is to the information for each of the entities in the concept entity graph. For example, similarities between the search terms in the search query and the key terms for entities in the concept entity graph may be used to prioritize the entities. In some aspects, the location of the user submitting the search may be compared with one or more locations associated with each entity and the entities may be prioritized based on the comparison. Profile information for the user may also be compared to information for the entity and used to prioritize the entities.

After the entities are prioritized, the entity module 220 identifies one of the entities based on the prioritization. At block 520, the advertisement module 230 determines whether an advertisement corresponds to the identified entity. For example, the advertisement module 230 can search a data repository to determine whether a relationship between the entity and an advertisement is stored therein.

If an advertisement that corresponds with the entity is found, the advertisement module 230, at block 525, provides the advertisement to the client device so that the advertisement can be displayed to the user that submitted the search. If an advertisement corresponding to the entity is not found, the advertisement module 230, at block 530, may select some other advertisement to display to the user or not display any advertisement to the user.

In some cases, the advertisement associated with an entity may be provided by the advertiser. Accordingly, the advertisement module 230 can retrieve the advertisement from the data repository and transmit the advertisement to the client device. If the advertiser specified a configuration for the advertisement, the advertisement module 230 can generate an advertisement that is consistent with the configuration and transmit the advertisement to the client device.

In other aspects, the advertisement module 230 may generate an advertisement without input from the advertiser. The advertisement generated by the advertisement module 230 may be generated before interface module 210 receives the search query submitted by the user (e.g., block 510 of FIG. 5) or may be generated in response to the user submitting the search query.

The ability to display advertisements based on an entity related to a search can provide advertisers with a different way to target their advertisements and can provide search services with a different way of receiving advertisement revenue. For example, advertisers are able to display advertisements based on one or more selected entities rather than, or in addition to, selected key terms.

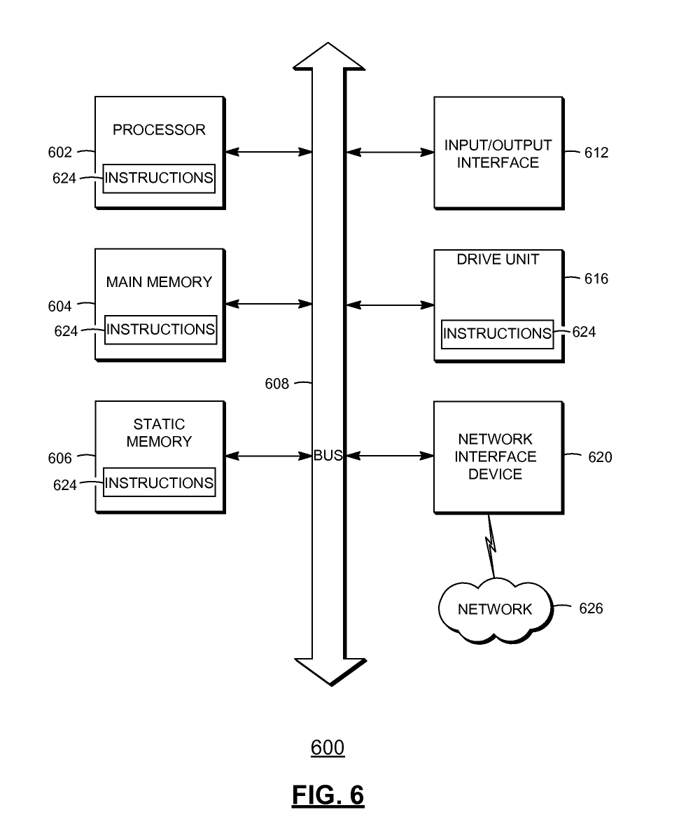

FIG. 6 is a block diagram illustrating a computer system 600 with which any of the devices, servers, or systems described herein may be implemented. In certain aspects, the computer system 600 may be implemented using hardware or a combination of software and hardware, either in a dedicated server, or integrated into another entity, or distributed across multiple entities.

The example computer system 600 includes a processor 602, a main memory 604, a static memory 606, a disk drive unit 616, and a network interface device 620 which communicate with each other via a bus 608. The computer system 600 may further include an input/output interface 612 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 602 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 624 embodying any one or more of the methodologies or functions described herein. The instructions 624 may also reside, completely or at least partially, within the main memory 604 and/or within the processor 602 during execution thereof by the computer system 600, with the main memory 604 and the processor 602 also constituting machine-readable media. The instructions 624 may further be transmitted or received over a network 626 via the network interface device 620.

The machine-readable medium may be a single medium or multiple media (e.g., a centralized or distributed database, and/or associated caches and servers) that store the one or more sets of instructions. The machine-readable medium may comprise the drive unit 616, the static memory 606, the main memory 604, the processor 602, an external memory connected to the input/output interface 612, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system.

Skilled artisans may implement the described functionality in varying ways for each particular application. For example, the modules may include software instructions encoded in a medium and executed by a processor, computer hardware components, or a combination of both. The modules may each include one or more processors or memories that are used to perform the functions described below. According to another aspect, the various systems and modules may share one or more processors or memories. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-implemented method for targeting an advertisement based on an entity, the method comprising:
receiving a search query submitted by a user;
identifying an entity in a concept entity graph based on the search query;
determining whether an advertisement corresponds to the identified entity; and
providing, if the advertisement corresponds to the entity, the advertisement for display to the user, wherein the advertisement comprises at least one social media component that corresponds to the entity.

2. The computer-implemented method of claim 1, wherein the at least one social media component comprises a link to a social network profile for the entity.

3. The computer-implemented method of claim 1, wherein the at least one social media component comprises an interface element to perform an action associated with a social network profile for the entity.

4. The computer-implemented method of claim 3, wherein the action associated with the social network profile for the entity comprises adding the social network profile for the entity to a list of social network profiles associated with the user.

5. The computer-implemented method of claim 3, wherein the action associated with the social network profile for the entity comprises sharing content in the social network profile for the entity on a social network profile for the user.

6. The computer-implemented method of claim 3, wherein the action associated with the social network profile for the entity comprises annotating content on the social network profile for the entity with a social endorsement.

7. The computer-implemented method of claim 3, further comprising:
determining whether the user interacts with the interface element to perform the action;
incrementing, if the user interacts with the interface element to perform the action, a interaction count; and
determining a fee for an advertiser associated with the advertisement based on the interaction count.

8. The computer-implemented method of claim 1, wherein the advertisement further comprises a link to purchase an item or service associated with the entity.

9. The computer-implemented method of claim 1, further comprising:
receiving a request to link the advertisement to the entity; and
storing, in response to the receiving of the request, a relationship between the advertisement and the entity in a data repository;
wherein the determining of whether the advertisement that corresponds to the entity comprises determining whether the relationship between the advertisement and the entity is stored in the data repository.

10. The computer-implemented method of claim 1, wherein the concept entity graph comprises mappings of key terms to entities, and wherein the identifying of the entity in the concept entity graph based on the search query comprises:
comparing search terms in the search query with the key terms in the concept entity graph; and
identifying the entity based on the comparison.

11. The computer-implemented method of claim 1, further comprising:
generating search results based on the search query; and
providing the search results to the user along with the advertisement.

12. The computer-implemented method of claim 1, wherein the identifying of the entity in the concept entity graph is based on information in the search query corresponding to information for the entity in the concept entity graph.

13. A system for targeting an advertisement based on an entity, the system comprising:
one or more processors; and
a machine-readable medium comprising instructions stored therein, which when executed by the one or more processors, cause the one or more processors to perform operations comprising:
receiving a search query submitted by a user;
identifying an entity in a concept entity graph based on the search query;
determining whether an advertisement corresponds to the identified entity; and
providing, if the advertisement corresponds to the entity, the advertisement for display to the user.

14. The system of claim 13, wherein the advertisement comprises at east one social media component that corresponds to the entity.

15. The system of claim 13, wherein the at least one social media component comprises a link to a social network profile for the entity.

16. The system of claim 13, wherein the at least one social media component comprises an interface element to perform an action associated with a social network profile for the entity.

17. The system of claim 13, wherein the operations further comprise:
receiving a request to link the advertisement to the entity; and
storing, in response to the received request, a relationship between the advertisement and the entity in a data repository;
wherein the determining of whether the advertisement that corresponds to the entity comprises determining whether the relationship between the advertisement and the entity is stored in the data repository.

18. The system of claim 13, wherein the operations further comprise:
generating search results based on the search query; and
providing the search results to the user along with the advertisement.

19. A machine-readable medium comprising instructions stored therein, which when executed by a machine, cause the machine to perform operations comprising:
receiving a search query submitted by a user;
identifying an entity based on the search query;
determining whether an advertisement corresponds to the identified entity; and
providing, if the advertisement corresponds to the entity, the advertisement for display to the user, wherein the advertisement comprises at least one social media component that corresponds to the entity.

20. The machine-readable medium of claim 19, wherein the identifying of the entity based on the search query comprises selecting the entity in a concept entity graph based on information in the search query corresponding to information for the entity in the concept entity graph.
